(19) United States
(12) Patent Application Publication
(10) Pub. No.: US 2003/0216954 A1
(43) Pub. Date: Nov. 20, 2003

(54) Apparatus and method for exchanging and storing personal information

(75) Inventor: David B. Buzzelli, Piscataway, NJ (US)

Correspondence Address: BURNS DOANE SWECKER & MATHIS L L P, POST OFFICE BOX 1404, ALEXANDRIA, VA, 22313-1404, US

(73) Assignee: David B. Buzzelli, Piscataway, NJ

(21) Appl. No.: 10/378,057

(22) Filed: Feb. 27, 2003

Related U.S. Application Data
(60) Provisional application No. 60/359,657, filed on Feb. 27, 2002.
(60) Provisional application No. 60/359,669, filed on Feb. 27, 2002.

(51) Int. Cl. G06F 17/60

(52) U.S. Cl. 705/10; 705/1

(57) ABSTRACT

A method and system for providing marketing accountability are provided. The system includes a plurality of handheld communicators containing signature information pertaining to an individual associated therewith; one or more data push devices each configured to perform information exchange with the plurality of handheld communicators and to receive the signature information contained therein; and a central information management source for compiling marketing accountability information based on the signature information obtained from the plurality of handheld communicators.

### CROSS-REFERENCE TO RELATED APPLICATIONS

This application claims priority under 35 U.S.C. §§119 and/or 365 to U.S. Provisional Applications Ser. Nos. 60/359,669 and 60/359,657, both of which were filed on Feb. 27, 2002, the entire contents of which are incorporated herein by reference.

### BACKGROUND OF THE INVENTION

### Field of the Invention

The invention relates to personal information storage and exchange devices.

### BRIEF SUMMARY OF THE INVENTION

In accordance with the invention, a system for providing marketing accountability is provided. The system includes a plurality of handheld communicators containing signature information pertaining to an individual associated therewith; one or more data push devices each configured to perform information exchange with the plurality of handheld communicators and to receive the signature information contained therein; and a central information management source for compiling marketing accountability information based on the signature information obtained from the plurality of handheld communicators.

Further in accordance with the invention, there is provided a method of compiling marketing information. The method includes providing a plurality of handheld communicators each containing signature information pertaining to an individual associated therewith; providing the signature information to one or more data push devices; forwarding the signature information from the one or more data push devices to a remote central information management source; and using the remote central information management source to compile marketing accountability information based on the signature information obtained from the plurality of handheld communicators.

### BRIEF DESCRIPTION OF THE SEVERAL VIEWS OF THE DRAWING(S)

Many advantages of the present invention will be apparent to those skilled in the art with a reading of this specification in conjunction with the attached drawings, wherein like reference numerals are applied to like elements.

FIG. 1 is a schematic representation of the communicator device in operation in accordance with the invention;

FIG. 2 is a block diagram of various components of the communicator device of the invention;

FIG. 3 is a block diagram of various functional modules of the invention;

FIG. 4 is schematic illustration of a data push device in operation in accordance with the invention;

FIG. 5 is a schematic illustration of a download and upload processes of the data push device of the invention; and

FIG. 6 is a schematic representation of network of data push devices interconnected to one another and to a central information management source in accordance with the invention.

### DETAILED DESCRIPTION OF THE INVENTION

In accordance with the invention, a communicator device and a data push device are provided. The communicator device is adapted for storage and exchange of personal information, and is used to load information from a PC (personal computer) through a standard USB (universal serial bus) port, and can share this information with other such devices, preferably on a file-by-file basis, and preferably through a wireless link. In this manner the communicator device enables a portable and convenient information exchange, without the need for major hardware such as the PC, laptop, or PDA (personal digital assistant).

The communicator device, when plugged into a PC, should appear as a hard disk to the system. The communicator device is provided with a control interface for controlling device-to-device sharing, and a display for displaying relevant information such as memory and power status, download status, and so forth. The communicator device allows the user to choose which electronic files to share. When plugged into a computer, the information is centrally managed. Additional features of the communicator device consist of send, receive and select controls and a display for viewing selected files to exchange. The communicator device is portable, and its likely uses include digital business card exchanges, trading card exchanges (sports, models, cars, characters, and so forth), digital photos, personal profiles, documents, spreadsheets, databases, presentations, MP3 music files, video trailers, e-signatures, passwords, digital certificates, financial information (employing IrFM), directions, promotions, advertisements, assignments, and mission critical files. The communicator device is suitable as a digital transaction enabler and can easily store and transfer personal, state, federal or digital information to and from retailers, kiosks, information desks, point-of-purchase terminals, or specially equipped displays.

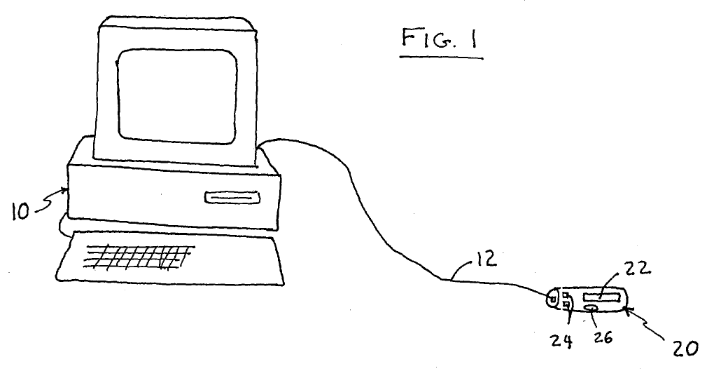

FIG. 1 shows a communicator device 20 in operation in accordance with the invention. A personal computer (PC) 10, which may be a desktop or a laptop type computer, is provided with a USB (Universal Serial Bus) port (not shown). The USB port is used to connect the PC 10 to communicator device 20. The connection is effected by plugging device 20 into the USB port of PC 10, or, as depicted, by way of a cable 12 which servers to transfer information bidirectionally between PC 10 and communicator device 20. Other bidirectional information transfer methods between PC 10 and communicator device 20 are possible, for example those using wireless optical (infra-red) or RF (radio-frequency) connections.

Communicator device 20 is provided with a display 22, for example an LCD (liquid crystal display) for furnishing information regarding different aspects of the operation of communicator device 20. A set of pushbutton or similar switches 24 is also provided, for the input of commands for performing specified tasks, and/or for effecting a power down mode to conserve battery life, as explained in greater detail below. An audio annunciator 26 provides audible feedback, which may be in the form of a click or beep, indicating that input entered via switches 24 has been accepted or rejected, or functions performed by communicator device 20 have been successfully completed or have failed. The audible annunciator can be permanent magnet speakers, piezoelectric disks, snap-action domes, solenoid clickers, and the like. In lieu of the audible feedback, feedback can be provided visually, by way of display 22, or of a separate LED (not shown).

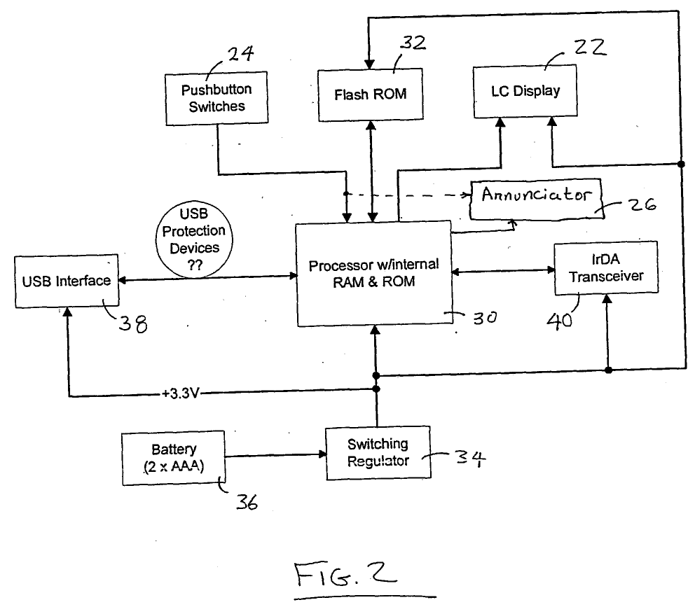

FIG. 2 is a block diagram of the internal components of communicator device 20. A processor 30 having internal memory (not shown) in the form of RAM (random access memory) and/or ROM (read only memory) is in communication with a main storage device 32, which is preferably non-volatile and is in the form of a flash memory device. Options for non-volatile memory devices include battery-backed SRAM, electronically erasable programmable read-only memory (EEPROM), NAND flash ROM, NOR flash ROM, ferro-electric RAM, and dynamic RAM with a battery powered refresh controller.

A switching regulator device 34 serves to control the power from a power source 36, such as a pair of AAA batteries which may be rechargeable, received by the various components, and is illustrated as providing 3.3 volts, for example, to these components. Processor 30 is also in communication with display 22, providing display commands thereto, and with pushbutton switches 24 for receiving input from a human operator (not shown). Processor 30 may also monitor battery life, and issue commands to display 22 or to a separate indicator, such as a dedicated LED, to provide indication of same. Annunciator 26 receives signals from processor 30, or, alternatively, directly from pushbutton switches 24, and generates audible feedback signals to the operator. Commensurate tactile feedback functions may be provided by pushbutton switches 24.

Processor 30 further communicates with USB interface device 38 to thereby receive information from and transmit information to computer 10 via cable 12 (FIG. 1). Similarly, processor 30 communicates with IrDA (Infra-red Data Association®) transceiver 40 such that information can be transmitted to other devices from communicator device 20, or received from the other devices. These other devices can be other information storage and exchange devices similar to communicator device 20, or they can be PDAs (personal digital assistant), or stand-alone data push devices adapted to broadcast information to a multiplicity of information storage and exchange devices 20. Information transfer is preferably performed using the IrDA 2.0 protocol, although other fast serial protocols, including those specific to the communicator device 20, may be used. In situations where communication with a PDA or other device is contemplated, a protocol which is capable of negotiating link speed, or adapting to the other device, may be used. In addition, other means of transferring information to and from communicator device 20 are contemplated, in lieu of transceiver 40 and/or USB interface device 38. Such other means include, but are not limited to, RF means, or optical means such as infra-red transceivers.

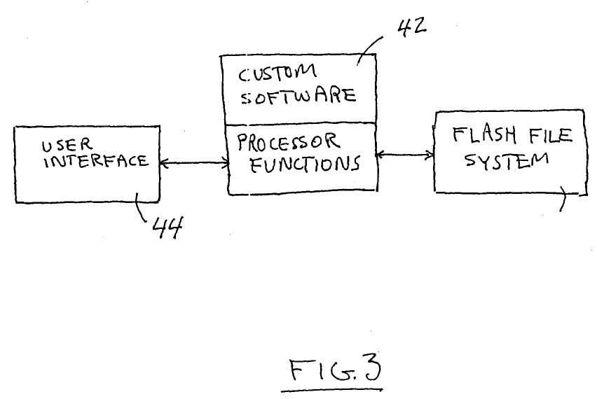

Turning to FIG. 3, processor 30 implements a file system for use with the particular memory device selected, for example a file system for a flash memory, or flash file system (FFS) 46, which includes a mechanism for distributing write and erase cycles over the entire memory device to maximize longevity. In addition, custom software 42, preferably in a high level language, is provided for implementing device specific functions of a user interface 44 and to link to the FFS is provided. Some features of the software 42 include implementation of data transfer procedures, including handshaking, encryption/decryption, checksum/CRC generation/checking. Other functions are USB and IrDA device drivers, file management (deletion, renaming, memory available/required for transfer, and so forth), error recovery (file corruption during transfer, bad memory block, and so forth) and human interface (menu navigation, display formatting, switch debounce/interpretation).

Communicator device 20 may be provided with a real-time clock whose functions include providing date and time stamps indicating file creation and/or modification. However, such information is normally contained in file headers on the equipment, such as a PC, from which the files originated, and real-time clock for this purpose therefore may not be necessary. Real-time clock and calendar functions can be implemented in software on processor 30 if it supports a crystal controlled timer function. The logic used to implement this capability would need to remain powered, consuming valuable battery life. Integrated real-time clock chips may alternatively be used, permitting the powering down of the processor.

Communicator device 20 can implement power management functions in order to assure maximum battery lifetime. A background timer to effect automatic power down if no user activity has occurred within a specified time can be used. Power can then be restored when a user-initiated action, such as switch activation, is detected. Alternatively, the communicator device 20 can function in an “always on” mode, using low power circuitry. Also, or alternatively, the clock frequency can be slowed when the device is not in use, and then speeded up when operations such as a file transfers have been requested. It will be appreciated however that completely shutting off the device will realize the most power saving, and expedients to effect this automatically following prolonged periods of disuse are preferred.

Since wireless file transfers are contemplated using communicator device 20, it may be useful to perform screening of broadcast information to prevent unwanted file transfers. To that end, user profiles can be established in communicator device 20, and only information matching specified parameters can be permitted to be automatically transferred. Alternatively, active user intervention, through switch activation, can be required prior to any transfer of files or other information.

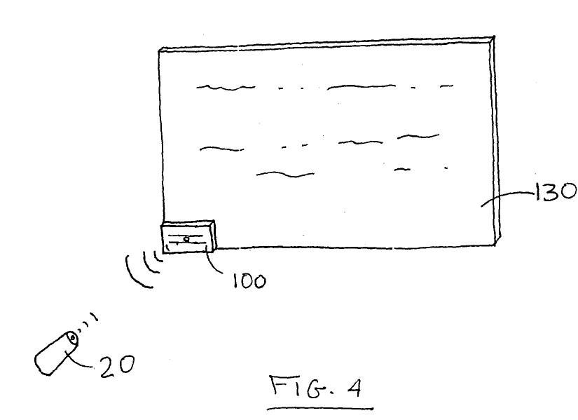

FIG. 4 shows a data push device 100 and a communicator device 20 in operation in accordance with the invention. Data push device 100 is depicted as affixed to, or provided in the vicinity of, a promotional advertisement means such as billboard 130. Communicator device 20 is portable in nature, and is carried by a user (not shown), for example in a subway station or any similar public or private forum. When communicator 20 reaches the transmission range of data push device 100, information is transmitted wirelessly, for example via infra-red, or via RF (radio frequency) signals from data push device 100.

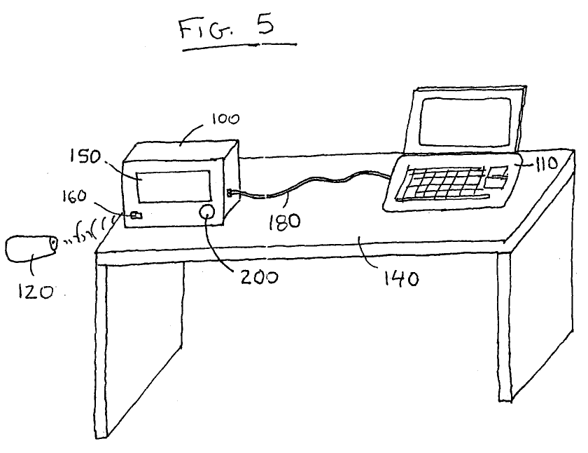

The data push device of the invention can also be part of a promotional display, for example at a trade show, or at an information booth. FIG. 5 shows such use, wherein data push device 100 is depicted as disposed on a counter 140 at a trade show. Data push device 100 is provided with a wireless interface, such as an infra-red sensor and transmitter designated collectively as 160. The sensor can be designed to automatically detect information query signals from a communicator 20 or similar device, such as a PDA (personal digital assistant), laptop computer, cellular telephone, and so forth, and to transmit the information contained in the data push device 100 to the querying device. The information can be related to the particular display at the trade show, and can be updatable through a link 180 with an information source 110, such as a laptop computer, or even a different communicator (not shown) similar to communicator 20. Link 180 may be wireless, using for example infra-red or RF (radio frequency), or it may be through a USB (universal serial bus) connection.

Once data push device 100 is downloaded with information from source 110, source 110 can be removed, leaving data push device 100 to function automatically, by sensing the presence of a communicator 20, or by sensing query signals from such a communicator. The data push device 100 then proceeds to transmit the information, preferably on a file-by-file basis, to communicator 20. Preferably, data push device 100 also receives information from the communicator 20, such as information pertaining to user contact information, demographics, and so forth.

Data push device 100 can be provided with a display 150 and a knob or other control means 200 to permit a user, for example the operator of communicator 20, to select the information desired for uploading. Data push device 100 can be provided with a cable (not shown) for plugging into a wall outlet for power. Alternatively, power can be provided internally, using suitably sized batteries.

In operation, communicator 20 and data push device 100 can be used to compile statistical information about the recipients of transmitted information and thereby provide marketing accountability and market intelligence gathering information, as discussed in greater detail below. The communicator 20 is used in the delivery of business information and rich content or wireless media, including graphics, spreadsheets, charts and applications.

Information exchange using the communicators 20 involves transmission of signature information, used to identify the information source, and to provide other information regarding this source—for example the origin user's name, address, age, sex, race, marital status, and so forth. In this manner, the communicator 20 furnishes a platform for gathering information for purposes of marketing, particularly when the communicator is used in conjunction with the data push device 100.

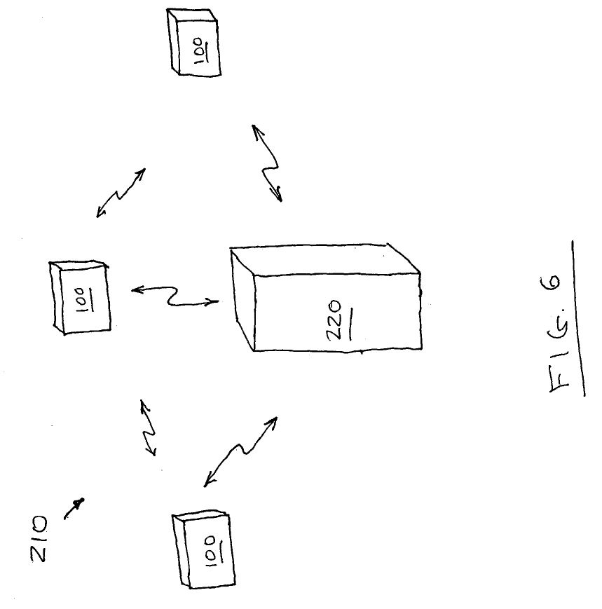

The data push device 100 broadcasts information for receipt by the portable communicator 20 and other mobile devices. In this context, the data push device 100 can be used for example at a booth at a trade show, or in conjunction with billboards or other advertisements, transmitting their promotional information either at large, or exclusively when the presence of one or more communicators 20 is sensed, or in response to affirmative requests by communicators 20 or other mobile devices. The data push device 100, using signatures and unique identifying information received from communicator 20 during information exchanges therewith, can provide a tool for compiling statistical information about the recipients of its transmitted information, and in this manner provide marketing accountability and market intelligence gathering information. As seen from FIG. 6, a network 210 of data push devices 100, interconnected to one another and to a central information management source 220 coordinating their operation and managing their content, is particularly suitable for this type of statistical information, and provide valuable demographic information based on the imbedded signature information and other market intelligence gathering information received in response to the information broadcast by the data push devices 100. Central information management source 220 may be for example a server or personal computer or other information processing device. The interconnection between central information management source 220 and devices 100 can be wireless, as illustrated in the FIG. 6, or it can be through other media, such as the Internet (not shown), or a combination of wireless and other media. The data push device 100 may be immobile—that is, it may be an onsite device which transmits information collected from multiple communicators 20 without having to be removed. The collected information may also be extracted from push device 100 as files using a communicator 20, which is brought into proximity thereto in order to effect an upload of the information from the push device to the communicator. The communicator 20 would then be physically taken to a central information management source 220, and the information transferred wirelessly or through cable, into the information management source 220.

The above are exemplary modes of carrying out the invention and are not intended to be limiting. It will be apparent to those of ordinary skill in the art that modifications thereto can be made without departure from the spirit and scope of the invention as set forth in the following claims.

What is claimed is:

1. A system for providing marketing accountability comprising:
a plurality of handheld communicators, wherein each handheld communicator contains signature information pertaining to an individual associated therewith;
one or more data push devices each configured to perform information exchange with the plurality of handheld communicators and to receive the signature information contained therein; and
a central information management source for compiling marketing accountability information based on the signature information obtained from the plurality of handheld communicators.

2. The system of claim 1, wherein the one or more data push devices provide promotional information to the plurality of handheld communicators.

3. The system of claim 1, wherein the central information management source compiles demographics information based on the signature information obtained from the plurality of handheld communicators.

4. The system of claim 2, wherein the one or more data push devices automatically send the promotional information when the presence of the a handheld communicator is sensed.

5. The system of claim 1, wherein the plurality of handheld communicators are configured to communicate with one another.

6. A method of compiling marketing information comprising:
providing a plurality of handheld communicators each containing signature information pertaining to an individual associated therewith;
providing the signature information to one or more data push devices; and
forwarding the signature information from the one or more data push devices to a remote central information management source; and
using the remote central information management source to compile marketing accountability information based on the signature information obtained from the plurality of handheld communicators.

7. The method of claim 6, further comprising sending promotional information from the one or more data push devices to one or more of the plurality of handheld communicators.

8. The method of claim 6, wherein the central information management source compiles demographics information based on the signature information obtained from the plurality of handheld communicators.

9. The method of claim 8, wherein the one or more data push devices automatically send the promotional information when the presence of the a handheld communicator is sensed.

10. The method of claim 9, further comprising exchanging information between the plurality of handheld communicators.
